(19) United States
(12) Patent Application Publication
(10) Pub. No.: US 2015/0326864 A1
(43) Pub. Date: Nov. 12, 2015

(54) METHOD AND TECHNICAL EQUIPMENT FOR VIDEO ENCODING AND DECODING

(71) Applicant: Nokia Technologies Oy, Espoo (FI)

(72) Inventor: Jani Lainema, Tampere (FI)

(21) Appl. No.: 14/703,013

(22) Filed: May 4, 2015

Related U.S. Application Data
(60) Provisional application No. 61/991,442, filed on May 9, 2014.

(51) Int. Cl. H04N 19/186; H04N 19/103; H04N 19/14; H04N 19/44

(52) U.S. Cl. CPC H04N 19/186; H04N 19/44; H04N 19/103; H04N 19/14

(57) ABSTRACT

The application relates to a method and technical equipment for decoding a coding unit being coded with palette mode, comprising decoding an indication of presence of escape coding within the coding unit; determining the size of the palette based on said indication of presence of escape coding; determining which palette index indicates escape coding for a sample; comparing a decoded palette index to said palette index indicating escape coding and in the case the indexes match, decoding sample value information; and assigning the decoded sample value for a sample within said coding unit. In addition, the application relates to a method and technical equipment for encoding.

### TECHNICAL FIELD

The present application relates generally to coding and decoding of digital material. In particular, the present application relates to scalable and high fidelity coding.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

Some embodiments provide a method for encoding and decoding video information. In some embodiments an apparatus, a computer program product, a computer-readable medium for implementing the method are provided.

Various aspects of examples of the invention are provided in the detailed description.

According to a first aspect, there is provided a method comprising:

decoding a coding unit being coded with palette mode, comprising
decoding an indication of presence of escape coding within the coding unit;
determining whether a flag indicating an escape coded sample value is to be decoded, which determination is based on said indication;
if the flag is to be decoded, decoding the value of said flag, and if the value of said flag indicates an escape coded pixel value, decoding sample value information;
assigning the decoded sample value for a sample within said coding unit.

According to an embodiment, the method comprises applying the indication of presence of escape coding within a coding unit to all samples in the coding unit.

According to an embodiment, the method comprises applying the indication of presence of escape coding within a coding unit to a subset of samples in the coding unit.

According to an embodiment, wherein the indication is a combination of higher level indication and a sample level indication.

According to an embodiment, the method further comprises indicating for a coding unit if there are escape coded samples, and if so, the method comprises indicating for at least one escape coded sample if that is the last escape coded sample in the coding unit.

According to an embodiment, the method further comprises including the indication in at least one of the following layers: sequence parameter set, picture parameter set, slice header, coding tree unit level, prediction unit level, transform unit level.

According to an embodiment, the method further comprises indicating the escape information by indicating a certain index in the palette to identify an escape coded sample.

According to a second aspect, there is provided an apparatus comprising at least one processor; and at least one memory including computer program code the at least one memory and the computer program code configured to, with the at least one processor, cause the apparatus to perform at least the following: decoding a coding unit being coded with palette coding, comprising
decoding an indication of presence of escape coding within the coding unit;
determining whether a flag indicating an escape coded pixel value is to be decoded, which determination is based on said indication;
if the flag is to be decoded, decoding the value of said flag, and if the value of said flag indicates an escape coded sample, decoding sample value information;
assigning the decoded sample value for a sample within said coding unit.

According to an embodiment, the apparatus is configured to apply indication of presence of escape coding within a coding unit to all samples in the coding unit.

According to an embodiment, the apparatus is configured to apply the indication of presence of escape coding within a coding unit to a subset of samples in the coding unit.

According to an embodiment, wherein the indication is a combination of higher level indication and a sample level indication.

According to an embodiment, the apparatus is configured to indicate for a coding unit if there are escape coded samples, and if so, the apparatus is configured to indicate for at least one escape coded sample if that is the last escape coded sample in the coding unit.

According to an embodiment, the apparatus is configured to include the indication in at least one of the following layers: sequence parameter set, picture parameter set, slice header, coding tree unit level, prediction unit level, transform unit level.

According to an embodiment, the apparatus is configured to indicate the escape information by indicating a certain index in the palette to identify an escape coded sample.

According to a third aspect, there is provided an apparatus comprising
means for processing;
means for decoding an indication of presence of escape coding within the coding unit;
means for determining whether a flag indicating an escape coded pixel value is to be decoded, which determination is based on said indication;
means for decoding a value of the flag, if the flag is to be decoded and if the value of said flag indicates an escape coded sample means for decoding are configured to decode sample value information; and
means for assigning the decoded sample value for a sample within said coding unit.

According to a fourth aspect, there is provided a computer program product comprising a computer-readable medium bearing computer program code embodied therein for use with a computer, the computer program code comprising:
code for decoding an indication of presence of escape coding within the coding unit;
code for determining whether a flag indicating an escape coded pixel value is to be decoded, which determination is based on said indication;
code for decoding the value of the flag, if the flag is to be decoded and code for decoding sample value information if the value of said flag indicates an escape coded sample; and
code for assigning the decoded sample value for a sample within said coding unit.

According to a fifth aspect, there is provided a non-transitory computer-readable medium encoded with instructions that, when executed by a computer, perform
decoding an indication of presence of escape coding within the coding unit;
determining whether a flag indicating an escape coded pixel value is to be decoded, which determination is based on said indication;
if the flag is to be decoded, decoding the value of said flag, and if the value of said flag indicates an escape coded sample, decoding sample value information;
assigning the decoded sample value for a sample within said coding unit.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a block diagram of a video coding system according to an embodiment;

FIG. 2 illustrates a layout of an apparatus according to an embodiment;

FIG. 3 illustrates an arrangement for video coding comprising a plurality of apparatuses, networks and network elements according to an embodiment;

FIG. 4 illustrates a block diagram of a video encoder according to an embodiment;

FIG. 5 illustrates a block diagram of a video decoder according to an embodiment;

FIG. 6 illustrates a method according to an embodiment as a flowchart; and

FIG. 7 illustrates a method according to an embodiments as a flowchart.

### DETAILED DESCRIPTION OF SOME EXAMPLE EMBODIMENTS

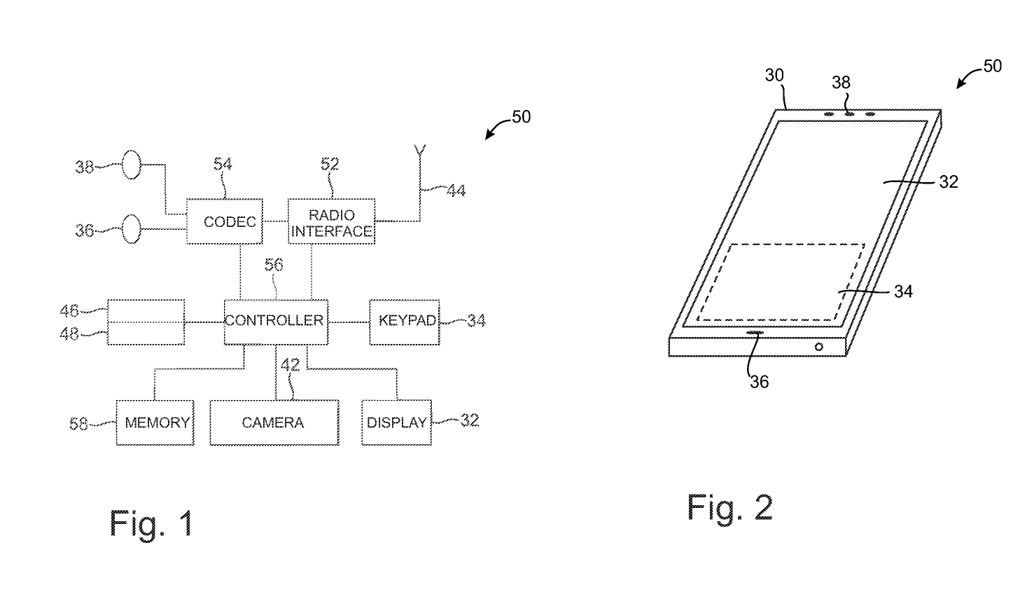

FIG. 1 shows a video coding system as a schematic block diagram of an apparatus or electronic device 50 according to an embodiment. The electronic device 50 may incorporate a codec according to an embodiment. FIG. 2 shows a layout of an apparatus according to an embodiment. The elements of FIGS. 1 and 2 will be explained next.

The electronic device 50 may for example be a mobile terminal or user equipment of a wireless communication system. However, it is appreciated that embodiments of the invention may be implemented within any electronic device or apparatus which may require encoding and decoding, or encoding or decoding video images.

The apparatus 50 may comprise a housing 30 for incorporating and protecting the device. The apparatus 50 further may comprise a display 32 in the form of a liquid crystal display. In other embodiments, the display may be any suitable display technology suitable to display an image or video. The apparatus 50 may further comprise a keypad 34. According to an embodiment, any suitable data or user interface mechanism may be employed. For example, the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device, which—according to an embodiment—may be any one of: an earpiece 38, speaker, or an analogue audio or digital audio output connection. The apparatus 50 may also comprise a battery 40 (or in an embodiment, the device may be powered by any suitable mobile energy device, such as solar cell, fuel cell or clockwork generator). The apparatus may further comprise a camera 42 capable of recording or capturing images and/or video. According to an embodiment, the apparatus 50 may further comprise an infrared port for short range line of sight communication to other devices. According to an embodiment, the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which according to an embodiment may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 56 may further comprise a card reader 48 and a smart card 46, for example a UICC and UICC reader for providing user information and being suitable for providing authentication information for authentication and authorization of the user at a network.

The apparatus 50 may further comprise a radio interface circuitry 52 connected to the controller and suitable for generating wireless communication signals for example for communication with a cellular communications network, a wireless communication system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

According to an embodiment, the apparatus 50 comprises a camera capable of recording or detecting individual frames which are then passed to the codec 54 or controller for processing. According to an embodiment, the apparatus may receive the video image data for processing from another device prior to transmission and/or storage. According to an embodiment, the apparatus 50 may receive either wirelessly or by a wired connection the image for coding/decoding.

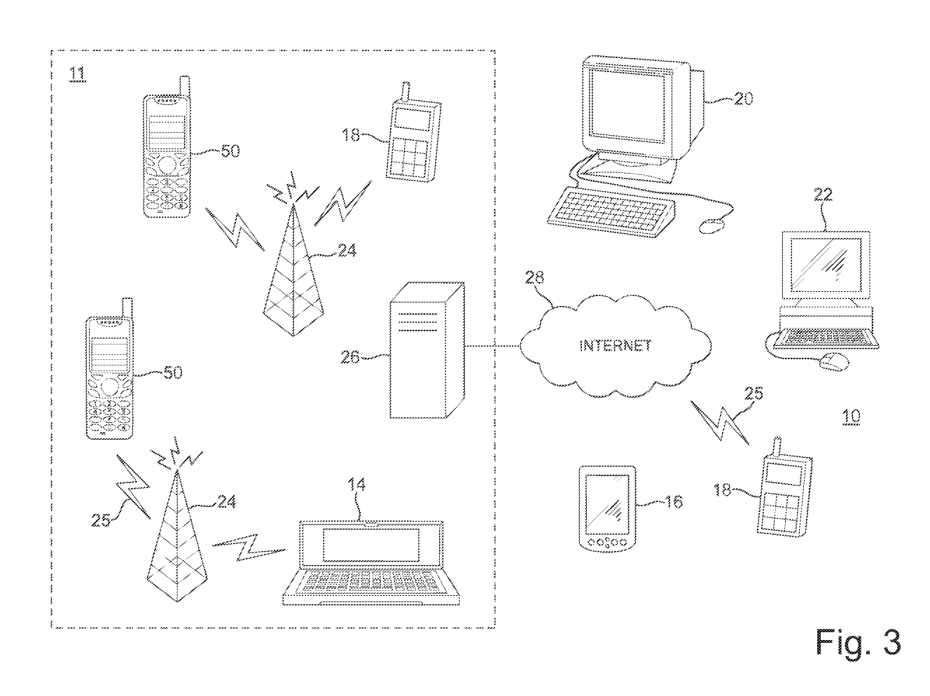

FIG. 3 shows an arrangement for video coding comprising a plurality of apparatuses, networks and network elements according to an embodiment. With respect to FIG. 3, an example of a system within which embodiments of the invention can be utilized is shown. The system 10 comprises multiple communication devices which can communicate through one or more networks. The system 10 may comprise any combination of wired or wireless networks including but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network and the Internet.

The system 10 may include both wired and wireless communication devices or apparatus 50 suitable for implementing embodiments. For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, any combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA) transmission control protocol-internet protocol (TCP-IP), short messaging service (SMS), multimedia messaging service (MMS) email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections and any suitable connection.

Video coder may comprise an encoder that transforms the input video into a compressed representation suited for storage/transmission, and a decoder is able to uncompress the compressed video representation back into a viewable form. The encoder may discard some information in the original video sequence in order to represent the video in more compact form (i.e. at lower bitrate).

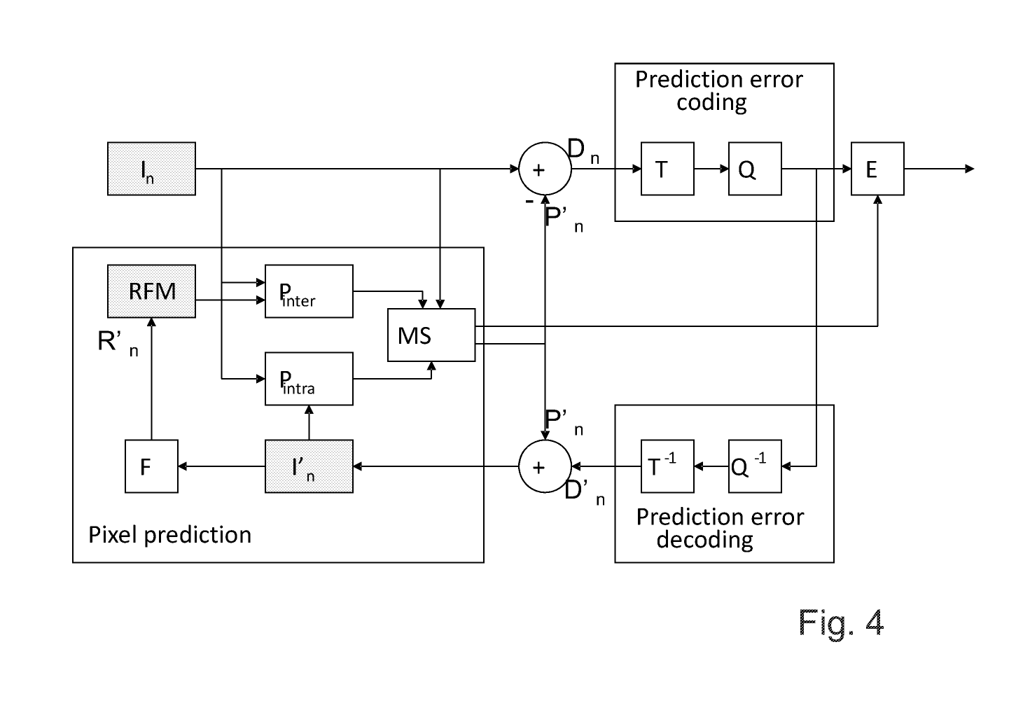

Hybrid video codecs, for example ITU-T H.263 and H.264, encode the video information in two phases. At first, pixel values in a certain picture are (or “block”) are predicted for example by motion compensation means (finding and indicating an area in one of the previously coded video frames that corresponds closely to the block being coded) or by spatial means (using the pixel values around the block to be coded in a specified manner). Secondly, the prediction error, i.e. the difference between the predicted block of pixels and the original block of pixels, is coded. This may be done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size of transmission bitrate). The encoding process is illustrated in FIG. 4. FIG. 4 illustrates an example of a video encoder, where Iₙ: Image to be encoded; P′ₙ: Predicted representation of an image block; Dₙ: Prediction error signal; D′ₙ: Reconstructed prediction error signal; I′ₙ: Preliminary reconstructed image; R′ₙ: Final reconstructed image; T, T⁻¹: Transform and inverse transform; Q, Q⁻¹: Quantization and inverse quantization; E: Entropy encoding; RFM: Reference frame memory; Pᵢₙₜₑᵣ: Inter prediction; Pᵢₙₜᵣₐ: Intra prediction; MS: Mode selection; F: Filtering.

In some video codecs, such as HEVC, video pictures are divided into coding units (CU) covering the area of the picture. A CU consists of one of more prediction units (PU) defining the prediction process for the samples within the CU and one or more transform units (TU) defining the prediction error coding process for the samples in said CU. A CU may consists f a square block of samples with a size selectable from a predefined set of possible CU sizes. A CU with the maximum allowed size may be named as CTU (coding tree unit) and the video picture is divided into non-overlapping CTUs. A CTU can be further split into a combination of smaller CUs, e.g. by recursively splitting the CTU and resultant CUs. Each resulting CU may have at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter-predicted Pus and intra prediction directionality information for intra predicted PUs). Similarly, each TU is associated with information describing the prediction error decoding process for the samples within the said TU (including e.g. DCT coefficient information). It may be signaled at CU level whether prediction error coding is applied or not for each CU. In the case there is no prediction errors residual associated with the CU, it can be considered there are no TUs for said CU. The division of the image into CUs, and division of CUs into PUs and TUs may be signaled in the bitstream allowing the decoder to reproduce the intended structure of these units.

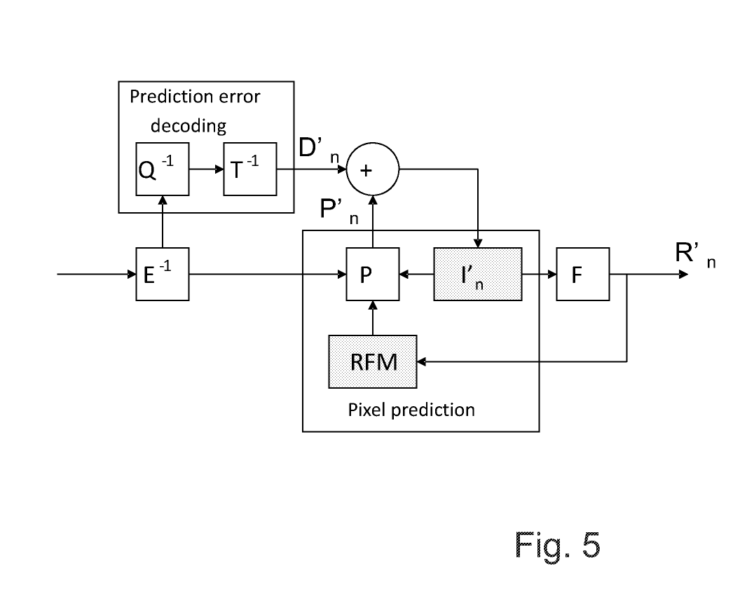

The decoded reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence. The decoding process is illustrated in FIG. 5. FIG. 5 illustrates a block diagram of a video decoder where P′ₙ: Predicted representation of an image block; D′ₙ: Reconstructed prediction error signal; I′ₙ: Preliminary reconstructed image; R′ₙ: Final reconstructed image; Inverse transform; Q⁻¹: Inverse quantization; E⁻¹: Entropy decoding; RFM: Reference frame memory; P: Prediction (either inter or intra); F: Filtering.

Instead, or in addition to approaches utilizing sample value prediction and transform coding for indicating the coded sample values, a color palette based coding can be used. Palette based coding refers to a family of approaches for which a palette, i.e. a set of colors and associated indexes, is defined and the value for each sample within a coding unit is expressed by indicating its index in the palette. Palette based coding can achieve good coding efficiency in coding units with a relatively small number of colors (such as image areas which are representing computer screen content, like text or simple graphics). In order to improve the coding efficiency of palette coding different kinds of palette index prediction approaches can be utilized, or the palette indexes can be run-length coded to be able to represent larger homogenous image areas efficiently. Also, in the case the CU contains sample values that are not recurring within the CU, escape coding can be utilized. Escape coded samples are transmitted without referring to any of the palette indexes. Instead their values are indicated individually for each escape coded sample.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

The motion information may be indicated in video codecs with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those vectors may be coded differentially with respect to block specific predicted motion vectors. In video codecs, the predicted motion vectors may be created in a predefined way, e.g. by calculating the median of the encoded or decoded motion vectors or the adjacent blocks. Another way to create motion vector predictions is to generate a list of candidate predictions from adjacent blocks and/or co-located blocks in temporal reference pictures and signalling the chose candidate as the motion vector prediction. In addition to predicting the motion vector values, the reference index of previously coded/decoded picture can be predicted. The reference index is typically predicted from adjacent blocks and/or co-located blocks in temporal reference picture. Moreover, high efficiency video codecs may employ an addition motion information coding/decoding mechanism, called “merging/merge mode”, where all the motion field information, which includes motion vector and corresponding reference picture index for each available reference picture list, is predicted and used without any modification/correction. Similarly, predicting the motion field information is carried out using the motion field information or adjacent blocks and/or co-located blocks in temporal reference pictures and the user motion field information is signaled among a list of motion field candidate list filled with motion field information of available adjacent/co-located blocks.

In addition to applying motion compensation for inter picture prediction, similar approach can be applied to intra picture prediction. In this case the displacement vector indicates where from the same picture a block of samples can be copied to form a prediction of the block to be coded or decoded. This kind of intra block copying methods can improve the coding efficiency substantially in presence of repeating structures within the frame—such as text or other graphics.

In video codecs, the prediction residual after motion compensation may be first transformed with a transform kernel (e.g. DCT) and then coded. The reason for this is that there may still exit some correlation among the residual and transform can in many cases help reduce this correlation and provide more efficient coding.

Video encoders may utilize Lagrangian cost functions to find optimal coding modes, e.g. the desired macroblock mode and associated motion vectors. This kind of cost function uses a weighting factor λ to tie together the (exact or estimated) image distortion due to lossy coding methods and the (exact or estimated) amount of information that is required to represent the pixel values in an image area:

C=D+λR

Where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Scalable video coding refers to coding structure where one bitstream can contain multiple representations of the content at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream may consist of a “base layer” providing the lowest quality video available and one or more enhancement layers that enhance the video quality when received and decoded together with the lower layers. In order to improve coding efficiency for the enhancement layers, the coded representation of that layer may depend on the lower layers. E.g. the motion and mode information of the enhancement layer can be predicted from lower layers. Similarly the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder are used. The reconstructed/decoded pictures of the base layer are included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability, there are also other scalability modes: spatial scalability, bit-depth scalability and chroma format scalability. In spatial scalability base layer pictures are coded at a higher resolution than enhancement layer pictures. In Bit-depth scalability base layer pictures are coded at lower bit-depth (e.g. 8 bits) than enhancement layer pictures (e.g. 10 or 12 bits). In chroma format scalability base layer pictures provide higher fidelity in chroma (e.g. coded in 4:4:4 chroma format) than enhancement layer pictures (e.g. 4:2:0 format).

In the above scalability cases, base layer information can be used to code enhancement layer to minimize the additional bitrate overhead.

Scalability can be enabled in two ways. Either by introducing new coding modes for performing prediction of pixel values or syntax from lower layers of the scalable representation or by placing the lower layer pictures to the reference picture buffer (decoded picture buffer, DPB) of the higher layer. The first approach is more flexible and thus can provide better coding efficiency in most cases. However, the second, reference frame based scalability, approach can be implemented very efficiently with minimal changes to single layer codecs while still achieving majority of the coding efficiency gains available. Essentially a reference frame based scalability codec can be implemented by utilizing the same hardware or software implementation for all the layers, just taking care of the DPB management by external means.

Escape coding of palette indexes refers to the process of indicating values for certain samples within a palette coded coding units that do not have good representations in the active palette. There are two basic approaches for indicating escape coded samples within a palette coding units. One of these approaches indicates by one bin whether a specific sample within a palette coding unit is escape coded or whether there is representative index in the palette that can be used to represent the sample value. In another approach, the escape coding information is embedded in the palette index syntax element. In this approach, the palette size is increased by one item as one of the items in the palette is used as the escape mode indicator.

In the following some examples will be provided. According to embodiments, indicators are inserted to the bitstream identifying when escape using is applicable and when a set of samples can be decoded without the need of escape coding. This has an effect of increasing the effectiveness of representing escape coding information within coding units utilizing palette coding.

According to an embodiment, a coding unit (CU) compressed in palette mode is decoded as follows:

At first, an indication on the presence of escape coding is decoded within a coding unit. Then, based on said indication, it is determined whether a flag indicating an escape coded pixel value is to be decoded. If a flag indicating an escape coded pixel value is to be decoded and said flag indicates an escape coded sample, sample value information is decoded. The decoded sample value is then assigned for a sample within said coding unit.

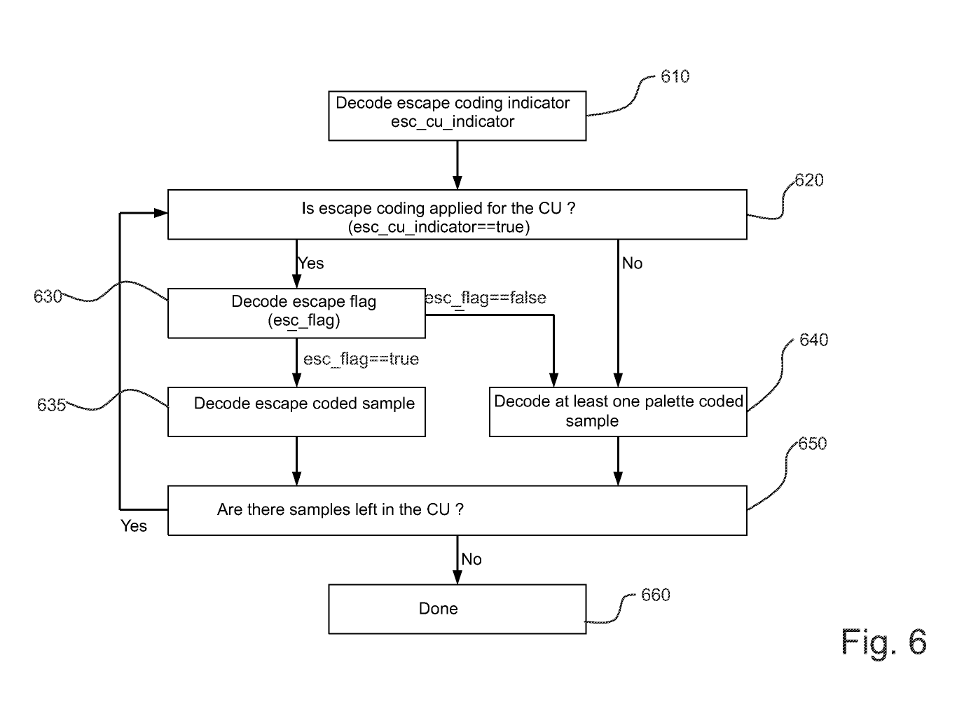

This can be implemented by a method according to an embodiment, illustrated in FIG. 6, and the pseudo-code in below. The numerals at the end of lines are reference numbers to FIG. 6.

| | |
|---|---|
| decode esc_cu_indicator | 610 |
| until (samples left in CU ) | 650, 660 |
| if (esc_cu_indicator ) | 620 |
| decode esc_flag | 630 |
| else | |
| set esc_flag = false | |
| if (esc_flag ) | |
| decode escape coded sample value | 635 |
| else | |
| decode at least one palette codec sample value | 640 |

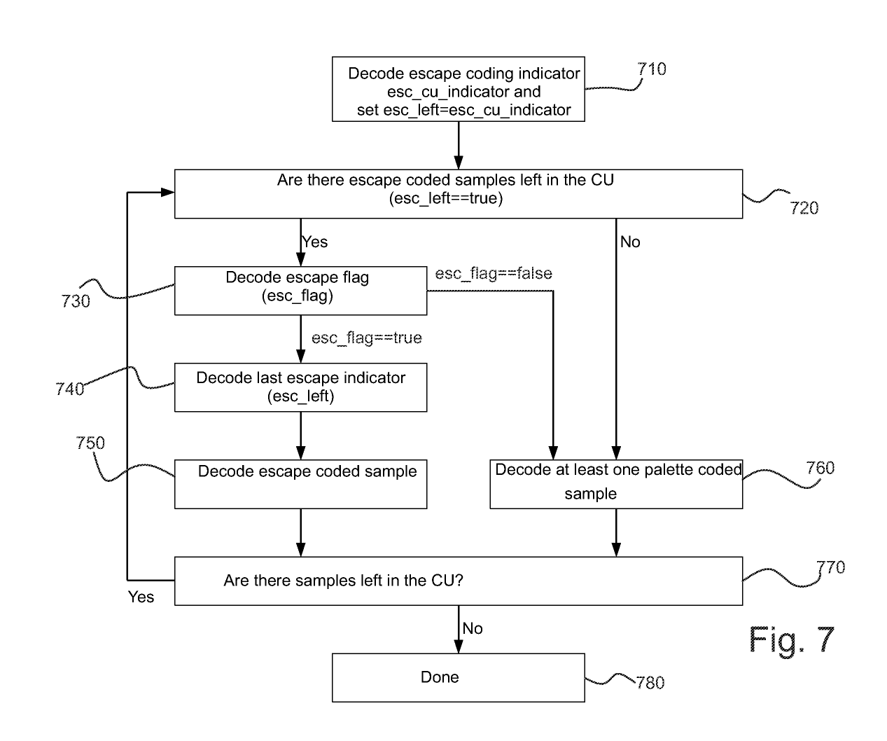

An alternative implementation is illustrated in FIG. 7. In this implementation, also sample level indicators are used for identifying the last escape coded sample of the coding unit with syntax element esc_left. A pseudo-code for this embodiment is given below. The numerals at the end of lines are reference numbers to FIG. 7.

| | |
|---|---|
| decode esc_cu_indicator | 710 |
| set esc_left = esc_cu_indicator | 710 |
| until (samples left in CU ) | 770, 780 |
| if (esc_left ) | 720 |
| decode esc_flag | 730 |
| else | |
| set esc_flag = false | |
| if (esc_flag ) | |
| decode esc_left | 740 |
| decode escape coded sample value | 750 |
| else | |
| decode at least one palette codec sample value | 760 |

There are alternatives to implement the embodiments.

For example, the indication can apply to a subset of samples in the CU. For example, there can be an indication for each coded sample identifying if the sample is the last escape coded sample in the CU.

As another example, the indication can be a combination of a higher level indication and a sample level indication. For example, it can be indicated for a CU if there are any escape coded samples and if so, it can be further indicated for at least one each escape coded sample if that is the last escape coded sample in the CU. According to an embodiment, it can be indicated for each escape coded sample if that is the last escape coded sample in the CU.

As another example, the indication can take place at different layers. For example, it can be included on a sequence parameter set, a picture parameter set, a slice header, a coding tree unit level, a coding unit level, a prediction unit level or a transform unit level.

As further example, the escape information can be indicated in different ways. For example, an escape coded sample can be identified by indicating a certain index in the palette. In this case the palette size can be reduced by one after receiving indication of a set of samples for which escape coding is not applied (and save bits when indicating subsequent palette indexes).

The non-escape coded samples can be coded in different ways. For example, the samples within one CU can be scanned in a predetermined way and it can be signaled if one of the following coding modes apply to a specific sample:
Copy from above mode: sample value is set equal to the value of the sample directly above the sample. In addition, it can be signaled how many consequent samples are predicted in similar fashion;
Run-length mode: sample value is set equal to a value signaled as a palette index for a number of consequent sample.

The embodiments provide advantages. For example, the coding efficiency of the palette based image/video coding is improved with virtually no effect on encoding or decoding complexity.

The various embodiments of the invention can be implemented with the help of computer program code that resides in a memory and causes the relevant apparatuses, such as encoder or decoder, to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

The various embodiments can be implemented with the help of a non-transitory computer-readable medium encoded with instructions that, when executed by a computer, perform the various embodiments.

If desired, the different functions discussed herein may be performed in a different order and/or concurrently with each other. Furthermore, if desired, one or more of the above-described functions may be optional or may be combined. Furthermore, the present embodiments are disclosed in relation to a method for decoding and to a decoder. However, the teachings of the present disclosure can be applied in an encoder configured to perform encoding of coding units and coding the indication the presence of escape coding within the coding unit.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

According to a first example, there is provided a method comprising:

decoding a coding unit being coded with palette mode, comprising
decoding an indication of presence of escape coding within the coding unit;
determining whether a flag indicating an escape coded sample value is to be decoded, which determination is based on said indication;
if the flag is to be decoded, decoding the value of said flag, and if the value of said flag indicates an escape coded sample, decoding sample value information;
assigning the decoded sample value for a sample within said coding unit.

According to an embodiment, the method comprises applying the indication of presence of escape coding within a coding unit to all samples in the coding unit.

According to an embodiment, the method comprises applying the indication of presence of escape coding within a coding unit to a subset of samples in the coding unit.

According to an embodiment, wherein the indication is a combination of higher level indication and a sample level indication.

According to an embodiment, the method further comprises indicating for a coding unit if there are escape coded samples, and if so, the method comprises indicating for at least one escape coded sample if that is the last escape coded sample in the coding unit.

According to an embodiment, the method further comprises including the indication in at least one of the following layers: sequence parameter set, picture parameter set, slice header, coding tree unit level, prediction unit level, transform unit level.

According to an embodiment, the method further comprises indicating the escape information by indicating a certain index in the palette to identify an escape coded sample.

According to a second example, there is provided an apparatus comprising at least one processor; and at least one memory including computer program code the at least one memory and the computer program code configured to, with the at least one processor, cause the apparatus to perform at least the following: decoding a coding unit being coded with palette coding, comprising
decoding an indication of presence of escape coding within the coding unit;
determining whether a flag indicating an escape coded pixel value is to be decoded, which determination is based on said indication;
if the flag is to be decoded, decoding the value of said flag, and if the value of said flag indicates an escape coded sample, decoding sample value information;
assigning the decoded sample value for a sample within said coding unit.

According to an embodiment, the apparatus is configured to apply indication of presence of escape coding within a coding unit to all samples in the coding unit.

According to an embodiment, the apparatus is configured to apply the indication of presence of escape coding within a coding unit to a subset of samples in the coding unit.

According to an embodiment, wherein the indication is a combination of higher level indication and a sample level indication.

According to an embodiment, the apparatus is configured to indicate for a coding unit if there are escape coded samples, and if so, the apparatus is configured to indicate for at least one escape coded sample if that is the last escape coded sample in the coding unit.

According to an embodiment, the apparatus is configured to include the indication in at least one of the following layers: sequence parameter set, picture parameter set, slice header, coding tree unit level, prediction unit level, transform unit level.

According to an embodiment, the apparatus is configured to indicate the escape information by indicating a certain index in the palette to identify an escape coded sample.

According to a third example, there is provided an apparatus comprising
means for processing;
means for decoding an indication of presence of escape coding within the coding unit;
means for determining whether a flag indicating an escape coded pixel value is to be decoded, which determination is based on said indication;
means for decoding the value of the flag, if the flag is to be decoded and if the value of said flag indicates an escape coded sample, means for decoding are configured to decode sample value information; and
means for assigning the decoded sample value for a sample within said coding unit.

According to a fourth example, there is provided a computer program product comprising a computer-readable medium bearing computer program code embodied therein for use with a computer, the computer program code comprising:

code for decoding an indication of presence of escape coding within the coding unit;
code for determining whether a flag indicating an escape coded pixel value is to be decoded, which determination is based on said indication;
code for decoding the value of the flag, if the flag is to be decoded and code for decoding sample value information if the value of said flag indicates an escape coded sample; and
code for assigning the decoded sample value for a sample within said coding unit.

According to a fifth example, there is provided a non-transitory computer-readable medium encoded with instructions that, when executed by a computer, perform
decoding an indication of presence of escape coding within the coding unit;
determining whether a flag indicating an escape coded pixel value is to be decoded, which determination is based on said indication;
if the flag is to be decoded, decoding the value of said flag, and if the value of said flag indicates an escape coded sample, decoding sample value information;
assigning the decoded sample value for a sample within said coding unit.

1. A method comprising:
decoding a coding unit being coded with palette mode, comprising
decoding an indication of presence of escape coding within the coding unit;
determining the size of the palette based on said indication of presence of escape coding;
determining which palette index indicates escape coding for a sample;
comparing a decoded palette index to said palette index indicating escape coding and in the case the indexes match, decoding sample value information; and
assigning the decoded sample value for a sample within said coding unit.

2. The method according to claim 1, further comprising
applying the indication of presence of escape coding within a coding unit to all samples or to a subset of samples in the coding unit.

3. The method according to claim 1, wherein the indication is a combination of higher level indication and a sample level indication.

4. The method according to claim 1, further comprising indicating for a coding unit if there are escape coded samples, and if so, the method comprises indicating for at least one escape coded sample if that is the last escape coded sample in the coding unit.

5. The method according to claim 1, further comprising including the indication in at least one of the following layers: sequence parameter set, picture parameter set, slice header, coding tree unit level, prediction unit level, transform unit level.

6. The method according to claim 1, further comprising indicating the escape information by a binary syntax element in the bitstream indicating that a certain sample is an escape coded sample.

7. A method comprising:
encoding a coding unit with palette mode, comprising
determining if at least one sample within a coding unit is to be escape coded;
encoding a flag indicating presence of escape coding within said coding unit;
determining size of a palette based on said indication of presence of escape coding;
determining which palette index indicates escape coding for a sample; and
indicating escape coding for at least one sample within said coding unit by encoding the value of the palette index indicating escape coding for a sample.

8. An apparatus comprising at least one processor; and at least one memory including computer program code the at least one memory and the computer program code configured to, with the at least one processor, cause the apparatus to perform at least the following: decoding a coding unit being coded with palette coding, comprising
decoding an indication of presence of escape coding within the coding unit;
determining the size of the palette based on said indication of presence of escape coding;
determining which palette index indicates escape coding for a sample;
comparing a decoded palette index to said palette index indicating escape coding and in the case the indexes match, decoding sample value information; and
assigning the decoded sample value for a sample within said coding unit.

9. The apparatus according to claim 8, further comprising computer program code to cause the apparatus to apply indication of presence of escape coding within a coding unit to all samples or to a subset of samples in the coding unit.

10. The apparatus according to claim 8, wherein the indication is a combination of higher level indication and a sample level indication.

11. The apparatus according to claim 8, further comprising computer program code to cause the apparatus to indicate for a coding unit if there are escape coded samples, and if so, the apparatus is configured to indicate for at least one escape coded sample if that is the last escape coded sample in the coding unit.

12. The apparatus according to claim 8, further comprising computer program code to cause the apparatus to include the indication in at least one of the following layers: sequence parameter set, picture parameter set, slice header, coding tree unit level, prediction unit level, transform unit level.

13. The apparatus according to claim 8, further comprising computer program code to cause the apparatus to indicate the escape information by a binary syntax element in the bitstream indicating that a certain sample is an escape coded sample.

14. An apparatus comprising at least one processor; and at least one memory including computer program code the at least one memory and the computer program code configured to, with the at least one processor, cause the apparatus to perform at least the following: encoding a coding unit with palette coding, comprising
determining if at least one sample within a coding unit is to be escape coded;
encoding a flag indicating presence of escape coding within said coding unit;
determining size of a palette based on said indication of presence of escape coding;
determining which palette index indicates escape coding for a sample; and
indicating escape coding for at least one sample within said coding unit by encoding the value of the palette index indicating escape coding for a sample.

15. A non-transitory computer-readable medium encoded with instructions that, when executed by a computer, perform
decoding an indication of presence of escape coding within the coding unit;
determining the size of the palette based on said indication of presence of escape coding;
determining which palette index indicates escape coding for a sample;
comparing a decoded palette index to said palette index indicating escape coding and in the case the indexes match, decoding sample value information; and
assigning the decoded sample value for a sample within said coding unit.

16. A non-transitory computer-readable medium encoded with instructions that, when executed by a computer, perform
determining if at least one sample within a coding unit is to be escape coded;
encoding a flag indicating presence of escape coding within said coding unit;
determining size of a palette based on said indication of presence of escape coding;
determining which palette index indicates escape coding for a sample; and
indicating escape coding for at least one sample within said coding unit by encoding the value of the palette index indicating escape coding for a sample.
